(19) United States
(12) Patent Application Publication
(10) Pub. No.: US 2025/0282407 A1
(43) Pub. Date: Sep. 11, 2025

(54) Baby Stroller

(71) Applicant: Nadege Jean, Houston, TX (US)

(72) Inventor: Nadege Jean, Houston, TX (US)

(21) Appl. No.: 18/598,308

(22) Filed: Mar. 7, 2024

(51) Int. Cl. B62B 9/12; B62B 7/00; B62B 9/10; B62B 9/26

(52) U.S. Cl. CPC B62B 9/12; B62B 7/008; B62B 9/104; B62B 9/26

(57) ABSTRACT

A multi-functional baby stroller may include an auxiliary stowable second (or multiple) seats. One or more additional seats may be provided through a side-to-side movement and/or a front-to-back movement without removal or addition of components to the baby stroller. At least one auxiliary stowable passenger seat (either foldable child seat folding under the primary seat to become one or an extra seat may be placed side-by-side) may be provided. The baby stroller may include a retractable canopy as well as a spring-loaded umbrella to provide shade or other weather protection for the passengers as well as the controllers of the baby stroller. Further, internal storage may be provided within or around the baby stroller. A baby strap carrier may be converted to a diaper changing pad attachable underneath the main seat or auxiliary seat of the stroller.

### FIELD OF THE DISCLOSURE

The present disclosure generally relates to baby strollers, and more particularly to baby strollers having various functionalities.

### BACKGROUND

Baby strollers can sometimes be bulky and heavy, such as when they include a variety of features and particularly when they are built to accommodate more than one child. Further, while some strollers have been construed to shift from accommodating only one child to more than one child, typically components needed to be added or removed to make this happen. In addition, while a cover or umbrella may be provided on a baby stroller to protect the child riding in the stroller, often the parent/caretaker who is pushing the baby stroller is not protected.

### SUMMARY

Embodiments of the present disclosure may provide a multi-functional baby stroller comprising: a primary seat; at least one auxiliary stowable passenger seat; a retractable canopy that may cover the primary seat and the at least one auxiliary stowable passenger seat; a spring-loaded umbrella that is capable of opening to cover a person operating the multi-functional baby stroller; and a storage area capable of receiving a diaper bag. The at least one auxiliary stowable passenger may be provided through a side-to-side movement without removal or addition of components to the baby stroller. The at least one auxiliary stowable passenger may be provided through a front-to-back movement without removal or addition of components to the baby stroller. The front-to-back movement may be through the at least one auxiliary stowable passenger seat folding under the primary seat. The storage area may be provided under the baby stroller. The storage area may be a baby strap carrier that is capable of being converted to a diaper changing pad attachable underneath the primary seat or the at least one auxiliary stowable passenger seat. The stroller may be formed of titanium and composite metals. The stroller also may include a slot at a side of the stroller to expand the at least one auxiliary stowable passenger seat. The spring-loaded umbrella may be detachable. The retractable canopy may be removable. The stroller also may include an extender portion capable of pulling forward to extend the baby stroller to receive the at least one auxiliary stowable passenger seat in a front-to-back direction. The stroller may further include a detachable foot rest capable of being stored in the storage area when not in use. The stroller may further include a detachable tray capable of being stored in the storage area when not in use. The stroller also may include an opening on a side of the baby stroller to allow a child riding in the baby stroller to see out the side of the baby stroller while seated. A detachable handle may be provided that may be capable of being stored in the storage area when not in use. A receiver may be provided to receive the spring-loaded umbrella when not in use. The receiver may include a fastening mechanism capable of securing the receiver around the spring-loaded umbrella for storage when not in use.

Other embodiments of the present disclosure may provide a multi-functional baby stroller comprising: a primary seat; at least one auxiliary stowable passenger seat; an extender portion capable of pulling forward to extend the baby stroller to receive the at least one auxiliary stowable passenger seat in a front-to-back direction; a slot at a side of the stroller to expand the at least one auxiliary stowable passenger seat; a retractable canopy that may cover the primary seat and the at least one auxiliary stowable passenger seat; a spring-loaded umbrella that is capable of opening to cover a person operating the multi-functional baby stroller; and a storage area capable of receiving a diaper bag. The storage area may be capable of receiving a plurality of detachable accessories selected from the group comprising: a handle, a foot rest, and a tray. The stroller may include a receiver that receives the spring-loaded umbrella when not in use.

### BRIEF DESCRIPTION OF THE DRAWINGS

For a more complete understanding of this disclosure, reference is now made to the following description, taken in conjunction with the accompanying drawings, in which:

FIG. 1 depicts a baby stroller according to an embodiment of the present disclosure;

FIG. 2 depicts a baby stroller according to another embodiment of the present disclosure;

FIGS. 3A-3B depict views of a baby stroller according to an embodiment of the present disclosure;

FIG. 4 depicts an exploded view of a baby stroller according to an embodiment of the present disclosure;

FIG. 5 depicts an exploded view of a baby stroller according to another embodiment of the present disclosure;

FIG. 6 depicts a view of a top portion of a baby stroller according to an embodiment of the present disclosure; and

FIG. 7 depicts another view of a top portion of a baby stroller according to an embodiment of the present disclosure.

### DETAILED DESCRIPTION

Embodiments of the present disclosure may provide a baby stroller having a plurality of accessories to lighten the burden and hassle of transportation with a baby or young child. A stroller according to embodiments of the present disclosure may provide a lightweight yet sturdy construction. The stroller may be formed of titanium and composite metals according to some embodiments of the present disclosure; however, other lightweight and sturdy materials may be utilized without departing from the present disclosure.

The stroller may convert from a double carrier to a single carrier without removal or addition of any component. While the stroller is described as converting between a double carrier and a single carrier, there may be other embodiments of the present disclosure where a stroller may be provided to receive more than two children. There may be a slot at the side of the stroller so that an additional stroller can be pulled out. Buttons may be provided on the side of the stroller to release the additional accessories.

A detachable and matching umbrella may be provided as part of the stroller to provide shelter for the parent/guardian pushing the stroller during inclement weather. However, it should be appreciated that the umbrella may not be detachable and/or may not be matching without departing from the present disclosure. The stroller may include a removable canopy that may cover the baby or child traveling in the stroller. While the canopy is described as removable, it should be appreciated that there may be embodiments where the canopy folds into the stroller when not in use without departing from the present disclosure. Further, it should be appreciated that the canopy may be substituted with an umbrella or other cover without departing from the present disclosure.

The stroller may further include an on-board diaper bag which may reduce the need to carry bulky or weight-adding accessories for attending to the baby or young child's needs while using the stroller. The stroller and the plurality of accessories may fold in together when closed and pop open when they are to be used.

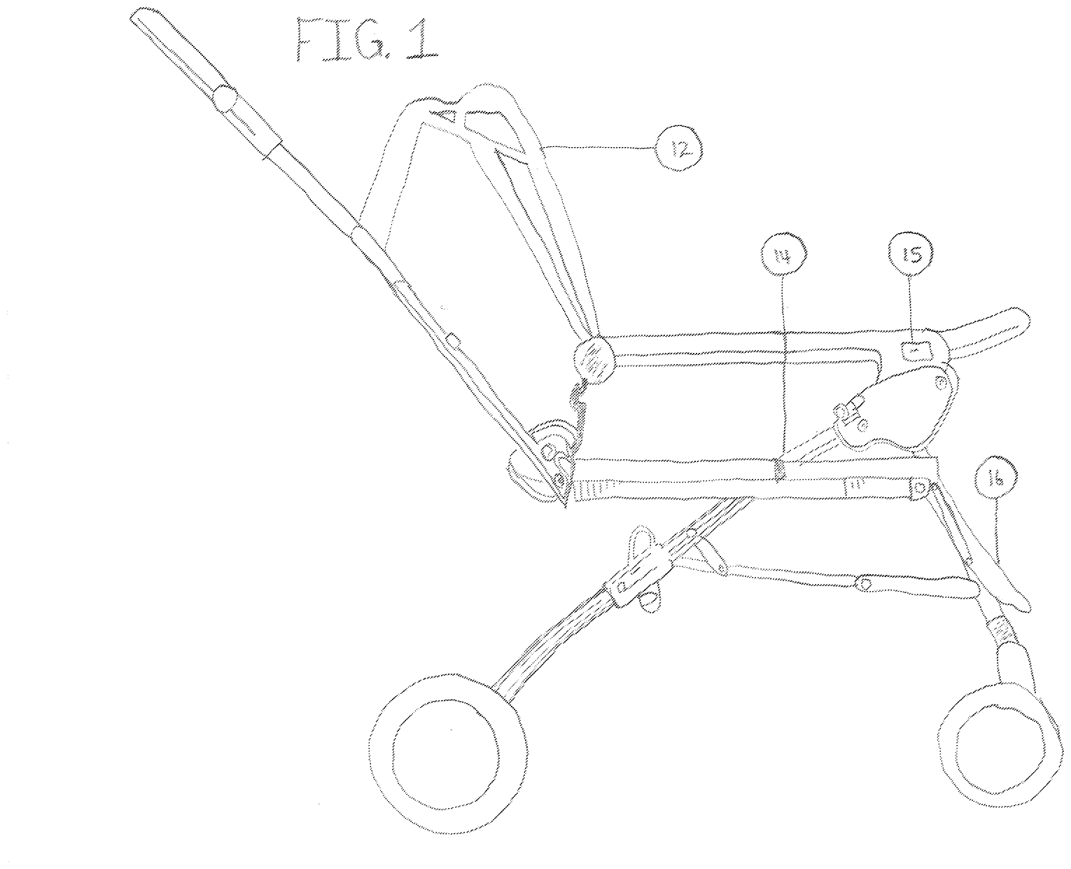

FIG. 1 depicts a baby stroller according to an embodiment of the present disclosure. A baby stroller may include canopy 12 when not in an extended position to cover the child (or children) riding in the baby stroller. Canopy 12 may cover the baby or child traveling in the stroller. While canopy 12 may be removable, it should be appreciated that there may be embodiments where canopy 12 folds into the stroller when not in use without departing from the present disclosure. Further, it should be appreciated that canopy 12 may be substituted with an umbrella or other cover without departing from the present disclosure. Slot 14 may be provided to assist in extending the stroller in a forward direction to receive more than one child. Slot 14 also may be provided so that an additional stroller seat can be pulled out. Extender portion 16 may be provided to pull forward to extend the stroller in a forward direction to receive more than one child in an embodiment of the present disclosure. Button 15 may be provided on the side of the stroller to release additional accessories.

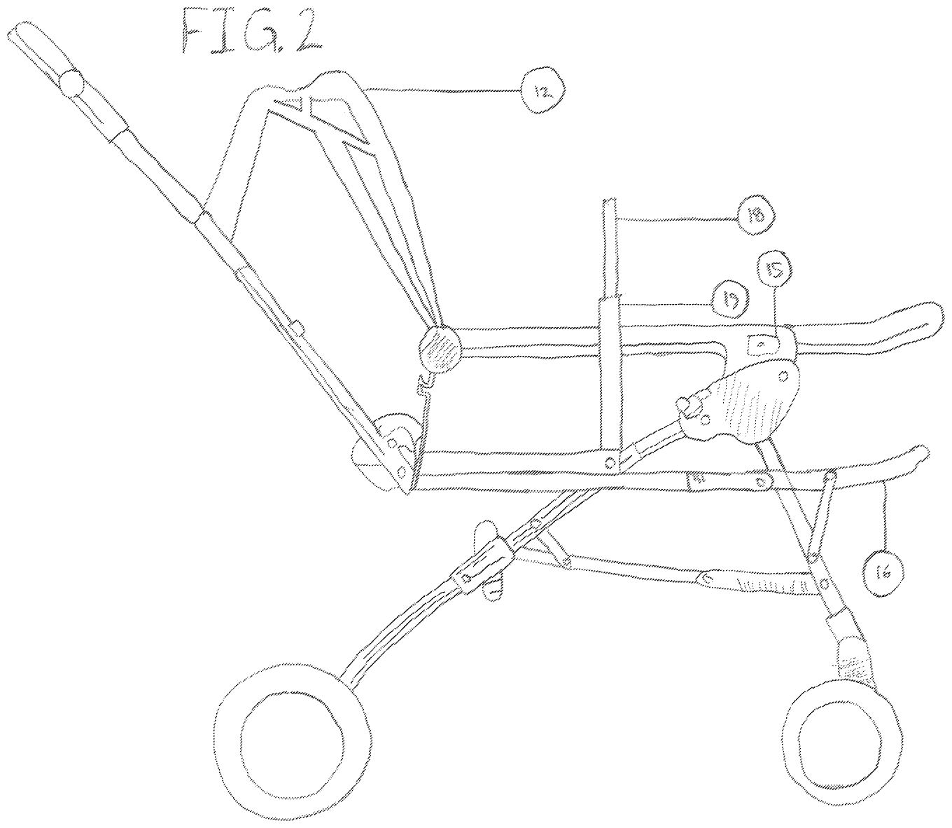

FIG. 2 depicts a baby stroller according to another embodiment of the present disclosure. As described with respect to FIG. 1, the baby stroller may include canopy 12 to cover the child (or children) riding in the baby stroller. Extender portion 16 may be provided to pull forward to extend the stroller in a forward direction to receive more than one child in an embodiment of the present disclosure. Button 15 may be provided on the side of the stroller to release additional accessories. Umbrella holder 13 may be provided such that it may be in a parallel position relative to extender portion 16 when not in use and then unfolded to a perpendicular position with extender 18 that may be telescoped to elevate above the stroller and receive an umbrella to cover/protect the person operating the stroller in the event of inclement weather or sun in embodiments of the present disclosure.

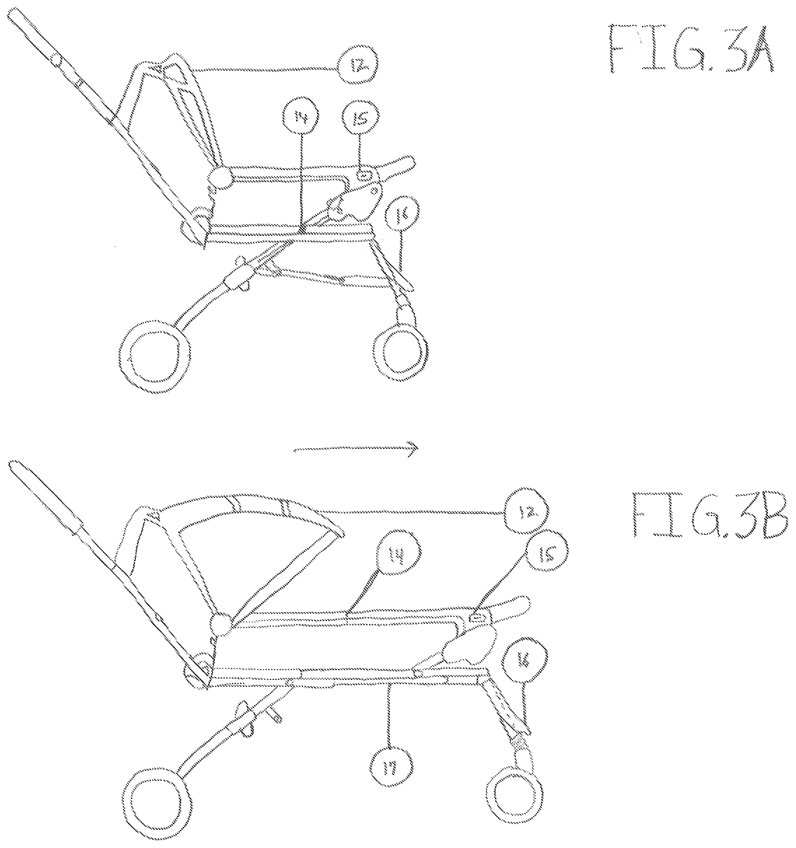

FIGS. 3A-3B depict views of a baby stroller according to an embodiment of the present disclosure. More specifically, FIG. 3A depicts the baby stroller including canopy 12 in an unused position to cover the child (or children) riding in the baby stroller. FIG. 3B depicts canopy 12 when it is an extended position covering at least one child in an embodiment of the present disclosure. Similarly, slot 14 is depicted in FIG. 3A when extender portion 16 has not been pulled in a forward direction to receive more than one child, while FIG. 3B depicts the position of slot 14 when extender portion 16 has been pulled in a forward direction to receive more than one child. Portion 17 (FIG. 3B) depicts a telescoped section of extender portion 16 when extender portion 16 has been pulled in a forward direction in an embodiment of the present disclosure. In embodiments of the present disclosure, the back seat slides into an open slot to create two seats within the baby stroller.

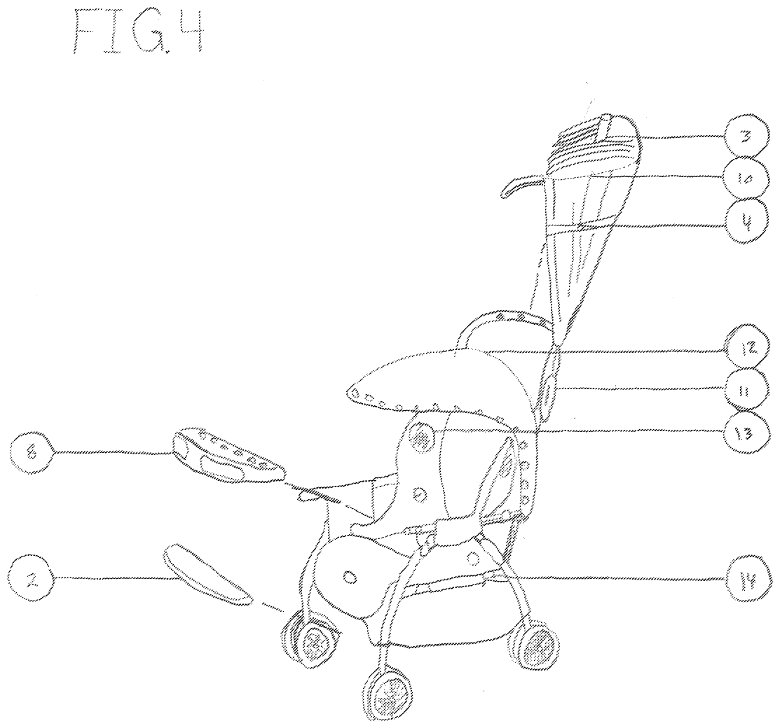

FIG. 4 depicts an exploded view of a baby stroller according to an embodiment of the present disclosure. More specifically, FIG. 4 depicts accessories being provided when the baby stroller is receiving a single child. As previously described in FIGS. 1-3, the baby stroller may include canopy 12. Slot 14 also is depicted below the seat of the baby stroller which may be utilized when the baby stroller is expanded to receive more than one child.

There may be a storage area below slot 14 in embodiments of the present disclosure. This storage area may be of a size that may receive a baby bag and/or removable components of the baby stroller in embodiments of the present disclosure. However, there may be other embodiments of the present disclosure where the storage area is a baby/diaper bag that may be secured to the baby stroller. In additional embodiments of the present disclosure, the baby/diaper bag may be secured to a back portion or a front portion of the baby stroller in addition to or in place of the storage area below slot 14.

Foot rest 2 may be provided for a child to place their feet on when riding in the baby stroller. It should be appreciated that foot rest 2 may be removable from the baby stroller and stored in embodiments of the present disclosure. However, there may be other embodiments of the present disclosure where foot rest 2 may be folded into the baby stroller when not in use. Tray 8 may be provided for a child to use when riding in the baby stroller. It should be appreciated that tray 8 may be removable from the baby stroller and stored in embodiments of the present disclosure. However, there may be other embodiments of the present disclosure where tray 8 may be folded into the baby stroller when not in use.

Button or release mechanism 11 may be provided to open umbrella 3, 4, 10 in embodiments of the present disclosure. However, FIG. 4 depicts umbrella 3, 4, 10 when in a closed position. The umbrella may include canopy/cover 3 that may extend over the person who is controlling the baby stroller. The umbrella may include seam 10 below canopy/cover 3 to hold canopy/cover in position when it is extended over the person controlling the baby stroller. Lower seam 4 also may be provided to give more structure to canopy/cover 3 when extended over the person controlling the baby stroller. A side of the baby stroller may include opening 13 that may allow the child riding in the baby stroller to see out the side of the baby stroller while riding.

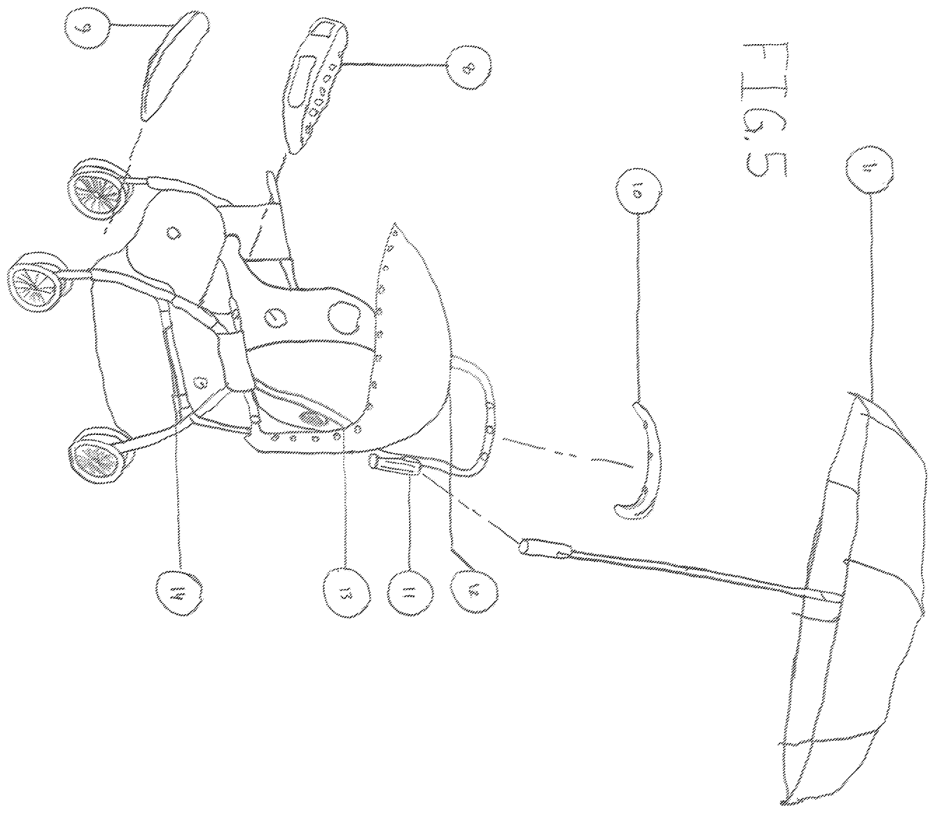

FIG. 5 depicts an exploded view of a baby stroller according to another embodiment of the present disclosure. More specifically, FIG. 5 depicts the umbrella is an open position relative to button or release mechanism 11. The baby stroller may include handle 10 that a person operating the baby stroller may use to control the baby stroller. It should be appreciated that handle 10 may be removable from the baby stroller in embodiments of the present disclosure. Similarly, tray 8 and/or foot rest 9 may be removable from the baby stroller in embodiments of the present disclosure.

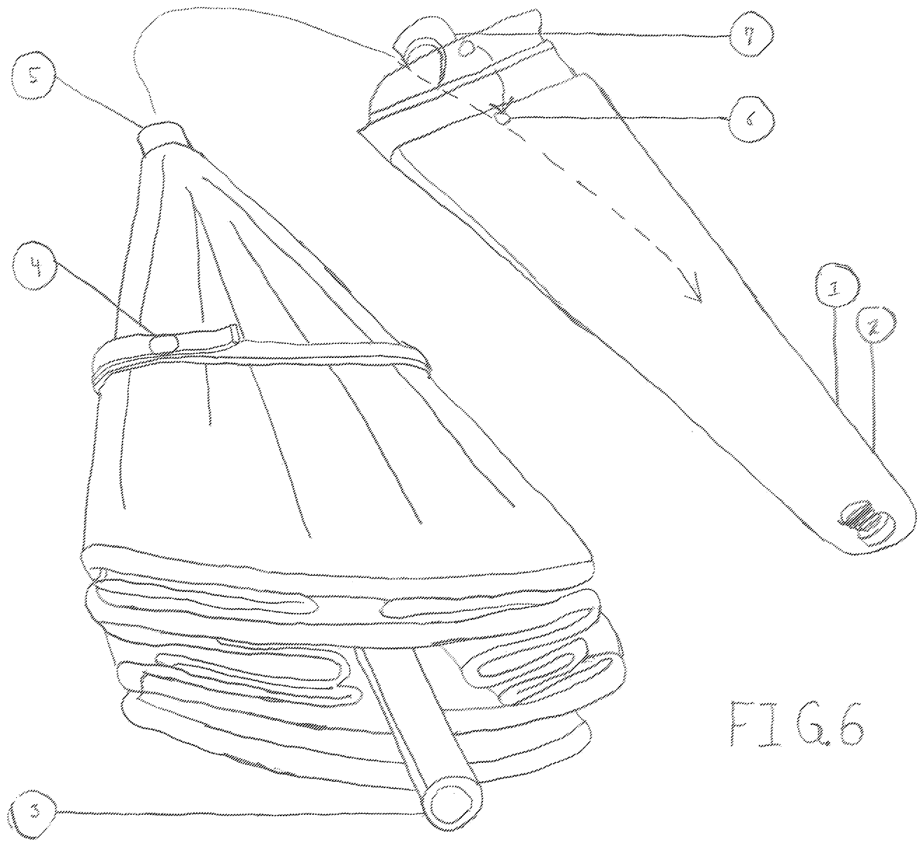

FIG. 6 depicts a view of a top portion of a baby stroller according to an embodiment of the present disclosure. More specifically, FIG. 6 depicts how the umbrella portion of the baby stroller may be moved from a folded position to be placed into a receiver when not in use. As depicted herein, the canopy/cover portion of the umbrella may be fastened through fastening mechanism 4. When fastened, the canopy/cover portion may be formed in a triangular position with pole 3, 5 extended out of each end of the canopy/cover portion in an embodiment of the present disclosure. Pole 5 may then be inserted into receiver 1 as depicted in FIG. 6. Once inserted, pole 5 may extended through receiver 1 at opening 2 in an embodiment of the present disclosure; however, there may be other embodiments of the present disclosure where pole 5 may not extend through receiver 1 or receiver 1 may not include opening 2. As pole 5 is inserted into receiver 3, the canopy/cover portion may be housed within receiver 1, and fastening mechanism 6, 7 may be used to secure receiver 1 around the umbrella in embodiments of the present disclosure.

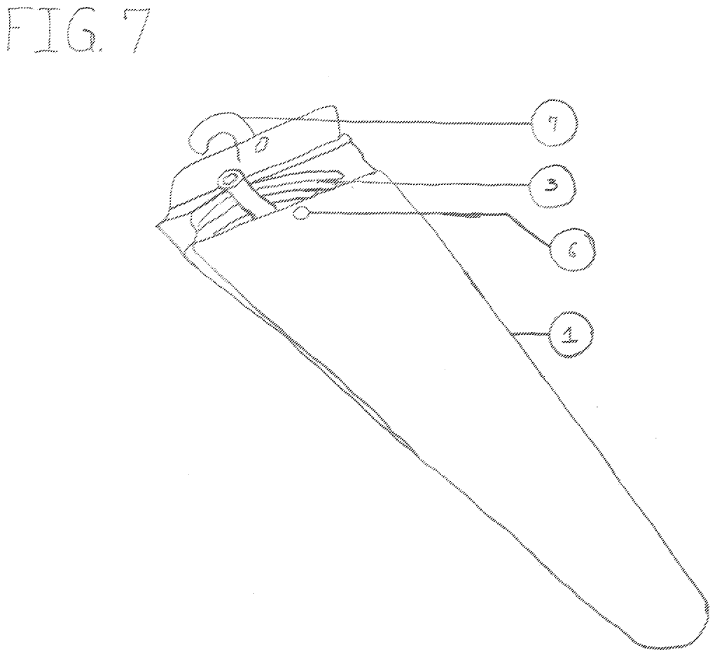

FIG. 7 depicts another view of a top portion of a baby stroller according to an embodiment of the present disclosure. More specifically, this view depicts receiver 1 wherein the umbrella has been inserted into receiver 1 and pole 3 and the canopy/cover portion are inside receiver 1. Fastening mechanism 6, 7 again may be used to secure receiver 1 around the umbrella once inserted within receiver 1 in embodiments of the present disclosure.

Accordingly, embodiments of the present disclosure may provide a multi-functional baby stroller including an auxiliary stowable second (or multiple) seats. It should be appreciated that more than one additional seat may be provided through a side-to-side movement and/or a front-to-back movement without removal or addition of components to the baby stroller. At least one auxiliary stowable passenger seat (either foldable child seat folding under the primary seat to become one or an extra seat may be placed side-by-side) may be provided. The baby stroller may include a retractable canopy as well as a spring-loaded (reversible) umbrella to provide shade or other weather protection for the passengers as well as the controllers of the baby stroller in embodiments of the present disclosure. Further, internal storage may be provided within or around the baby stroller in embodiments of the present disclosure. In an embodiment of the present disclosure, a baby strap carrier may be converted to a diaper changing pad attachable underneath the main seat or auxiliary seat of the stroller.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A multi-functional baby stroller comprising:
a primary seat;
at least one auxiliary stowable passenger seat;
a retractable canopy that covers the primary seat and the at least one auxiliary stowable passenger seat;
a spring-loaded umbrella that is capable of opening to cover a person operating the multi-functional baby stroller; and
a storage area capable of receiving a diaper bag.

2. The multi-functional baby stroller of claim 1 wherein the at least one auxiliary stowable passenger is provided through a side-to-side movement without removal or addition of components to the baby stroller.

3. The multi-functional baby stroller of claim 1 wherein the at least one auxiliary stowable passenger is provided through a front-to-back movement without removal or addition of components to the baby stroller.

4. The multi-functional baby stroller of claim 3 wherein the front-to-back movement is through the at least one auxiliary stowable passenger seat folding under the primary seat.

5. The multi-functional baby stroller of claim 1 wherein the storage area is provided under the baby stroller.

6. The multi-functional baby stroller of claim 1 wherein the storage area is a baby strap carrier that is capable of being converted to a diaper changing pad attachable underneath the primary seat or the at least one auxiliary stowable passenger seat.

7. The multi-functional baby stroller of claim 1 wherein the stroller is formed of titanium and composite metals.

8. The multi-functional baby stroller of claim 1 further comprising:
a slot at a side of the stroller to expand the at least one auxiliary stowable passenger seat.

9. The multi-functional baby stroller of claim 1, wherein the spring-loaded umbrella is detachable.

10. The multi-functional baby stroller of claim 1, wherein the retractable canopy is removable.

11. The multi-functional baby stroller of claim 1 further comprising:
an extender portion capable of pulling forward to extend the baby stroller to receive the at least one auxiliary stowable passenger seat in a front-to-back direction.

12. The multi-functional baby stroller of claim 1 further comprising:
a detachable foot rest capable of being stored in the storage area when not in use.

13. The multi-functional baby stroller of claim 1 further comprising:
a detachable tray capable of being stored in the storage area when not in use.

14. The multi-functional baby stroller of claim 1 further comprising:
an opening on a side of the baby stroller to allow a child riding in the baby stroller to see out the side of the baby stroller while seated.

15. The multi-functional baby stroller of claim 1 further comprising:
a detachable handle capable of being stored in the storage area when not in use.

16. The multi-functional baby stroller of claim 1 further comprising:
a receiver that receives the spring-loaded umbrella when not in use.

17. The multi-functional baby stroller of claim 16, the receiver further comprising:
a fastening mechanism capable of securing the receiver around the spring-loaded umbrella for storage when not in use.

18. A multi-functional baby stroller comprising:
a primary seat;
at least one auxiliary stowable passenger seat;
an extender portion capable of pulling forward to extend the baby stroller to receive the at least one auxiliary stowable passenger seat in a front-to-back direction;
a slot at a side of the stroller to expand the at least one auxiliary stowable passenger seat;
a retractable canopy that covers the primary seat and the at least one auxiliary stowable passenger seat;
a spring-loaded umbrella that is capable of opening to cover a person operating the multi-functional baby stroller; and
a storage area capable of receiving a diaper bag.

19. The multi-functional baby stroller of claim 18, wherein the storage area is capable of receiving a plurality of detachable accessories selected from the group comprising:
a handle, a foot rest, and a tray.

20. The multi-functional baby stroller of claim 18 further comprising:
a receiver that receives the spring-loaded umbrella when not in use.
